(19) United States
(12) Patent Application Publication
(10) Pub. No.: US 2016/0322886 A1
(43) Pub. Date: Nov. 3, 2016

(54) Water Generator System

(71) Applicant: Joseph Brienze, JR., Somerville, MA (US)

(72) Inventor: Joseph Brienze, JR., Somerville, MA (US)

(21) Appl. No.: 15/139,104

(22) Filed: Apr. 26, 2016

Related U.S. Application Data
(60) Provisional application No. 62/154,951, filed on Apr. 30, 2015.

(51) Int. Cl. H02K 7/18; F01D 15/10

(52) U.S. Cl. CPC H02K 7/1823; F01D 15/10

(57) ABSTRACT

A water generator system for providing power without using fossil fuels and placing strain on a power grid is provided. The water generator system comprises an intake pipe with pressurized water entering: the intake pipe. A housing is fluidly connected to the intake pipe. An impeller is rotatably mounted within the housing with the impeller rotatable by the pressurized water. An exit pipe is fluidly connected to the housing for receiving water from the housing. A coupling shaft is connected to and rotatable with the impeller. An electric generator is connected to the coupling shaft. The electric generator creates electrical power.

### CLAIM OF PRIORITY

This patent application claims priority under 35 USC 119 (e) (1) from U.S. Provisional Patent Application Ser. No. 62/154,951 filed Apr. 30, 2015, of common inventorship herewith entitled, “Aqua Generator,” which is incorporated herein by reference as though the same were set forth in its entirety.

### FIELD OF THE INVENTION

The present invention pertains to the field of energy production, and more specifically to the field of energy generating systems.

### BACKGROUND OF THE INVENTION

In a world hungry for clean and efficient sources of energy, inventors and engineers have turned their efforts toward capturing virtually unlimited supplies of energy from moving winds, sunlight, ocean tides, nuclei of atoms, and other renewable sources that might replace our current dependence on finite supplies of the fossil fuels bound up in the earth's sedimentary rocks such as coal, oil, natural gas, methane, oil sands and shale. Beyond the search for new energy sources, inventors and engineers seek higher levels of efficiency in energy converting machines from hybrid automobiles to household electric appliances. The First Law of Thermodynamics states that energy can be neither created nor destroyed, but only converted from one form to another.

Taking the chemical potential energy of gasoline and using the heat of combustion and the expansion of gases, an automobile converts potential energy into kinetic energy that turns the driveshaft and moves the car. Batteries are a source of potential energy. When connected to an electrical circuit, batteries release a stream of electrons, an electric current, which then is converted into work. In a simple generator, a coil of conducting wire is placed between two magnets and spun, inducing an electric current. The generator's Alternating Current or AC, in which electrons move back and forth, differs from a battery's. Direct Current or DC, in which electrons always flow in one direction from negative to positive.

Generators range from huge hydroelectric turbines that power cities to gas powered emergency generators that consumers use during power outages to generators which help to maintain the charge in our car batteries. All generators depend on a motive force to spin their coils. In a hydroelectric turbine, the force of flowing water rotates fins and the fins rotate a revolving shaft that rotates the coils. Gas powered generators use an internal combustion engine and a driveshaft to rotate coils. The coils in the generator of a car are spun by a driveshaft connected to a belt driven by the engine. To generate electricity, a generator requires an input of kinetic or mechanical energy.

The prior art has put forth several designs for energy generating systems. Among these are:

U.S. Pat. No. 6,765,308 to Harry Kazanjian and Margaret Kazanjian describes a hydro energy conversion system that comprises a hydraulic turbine rotor, a turbine housing that is rotatably connected to the hydraulic turbine rotor and a turbine cover that is detachably connected to the turbine housing. A mounting flange is connected to the turbine housing. An input plumbing fitting is connected to the turbine housing. An output plumbing fitting is connected to the turbine housing. A generator is coupled to the hydraulic turbine rotor.

U.S. Pat. No. 4,488,055 to James Toyama describes a fluid motor consisting essentially of a housing mounted on a water pipe and containing a vaned disc which functions as a paddle wheel whereby fluid moving through the conduit engages the vanes driving the disc and an output shaft associated therewith which in turn is utilized to drive a generator and produce an electric current.

U.S. Pat. No. 4,142,367 to Vito Guisti describes a fluid motor including a rotatable output shaft. A fluid inlet and a fluid outlet is provided for serial connection in a domestic water system supply pipe. A rotary electrical generator is provided and the output shaft of the fluid motor is drivingly coupled to the generator. A bank of storage batteries is further provided and the generator includes a pair of electrical potential output conductors electrically connected to the bank of batteries through current regulating structure whereby the batteries may be recharged as a result of the fluid motor driving the generator. An auxiliary domestic electrical wiring system is provided and is electrically connected to the bank of storage batteries.

None of these prior art references describe the present invention.

### SUMMARY OF THE INVENTION

It is an object of the present invention to provide an alternative energy source that contains a water pressure operated generator system which provides power without using fossil fuels and placing strain on a power grid.

The present invention is a water generator system for providing power without using fossil fuels and placing strain on a power grid. The water generator system comprises an intake pipe fluidly having a first end and a second end with pressurized water entering through the first end of the intake pipe. A housing is fluidly connected to the second end of the intake pipe. An impeller is rotatably mounted within the housing with the impeller rotatable by the pressurized water. an exit pipe is provided having a first end and a second end. The first end of the exit pipe is fluidly connected to the housing for receiving water from the housing. A coupling shaft is provided having a first end and a second end. The first end of the coupling shaft is connected to and rotatable with the impeller. An electric generator is connected to the second end of the coupling shaft. The electric generator creates electrical power.

In addition, the present invention further comprises a method for providing power without using fossil fuels and placing strain on a power grid. The method comprises providing an intake pipe fluidly having a first end and a second end, introducing pressurized water through the first end of the intake pipe, fluidly connecting a housing to the second end of the intake pipe, rotatably mounting an impeller within the housing, providing an exit pipe having a first end and a second end, fluidly connecting the first end of the exit pipe to the housing for receiving water from the housing, providing a coupling shaft having a first end and a second end, connecting the first end of the coupling shaft to the impeller, rotating the impeller by the pressurized water, rotating the coupling shaft, connecting an electric generator to the second end of the coupling shaft, and creating electrical power.

The present invention further includes a water generator system for providing power without using fossil fuels and placing strain on a power grid. The water generator system comprises an intake pipe fluidly having a first end and a second end with pressurized water entering through the first end of the intake pipe. A first automatic shut off valve is mounted on the intake pipe to automatically open and close the intake pipe upon the occurrence of a predetermined event. A first manual shut off valve is mounted on the intake pipe to manually open and close the intake pipe. A housing is fluidly connected to the second end of the intake pipe. An impeller is rotatably mounted within the housing with the impeller rotatable by the pressurized water. an exit pipe is provided having a first end and a second end. The first end of the exit pipe is fluidly connected to the housing for receiving water from the housing. A coupling shaft is provided having a first end and a second end. The first end of the coupling shaft is connected to and rotatable with the impeller. An electric generator is connected to the second end of the coupling shaft. A bypass pipe is provided having a first end fluidly connected adjacent the first end of the intake pipe and a second end fluidly connected adjacent the second end of the exit pipe. A second automatic shut off valve is mounted on the bypass pipe to automatically open and close the bypass pipe upon the occurrence of a predetermined event. A second manual shut off valve is mounted on the bypass pipe to manually open and close the bypass pipe. The electric generator creates electrical power.

### BRIEF DESCRIPTION OF THE DRAWINGS

FIG. 1 is a perspective view illustrating a water generator system, constructed in accordance with the present invention, with a generator, a drive shaft, a bypass pipe, a check valve, an impeller, and numerous automatic and manual shut off valves.

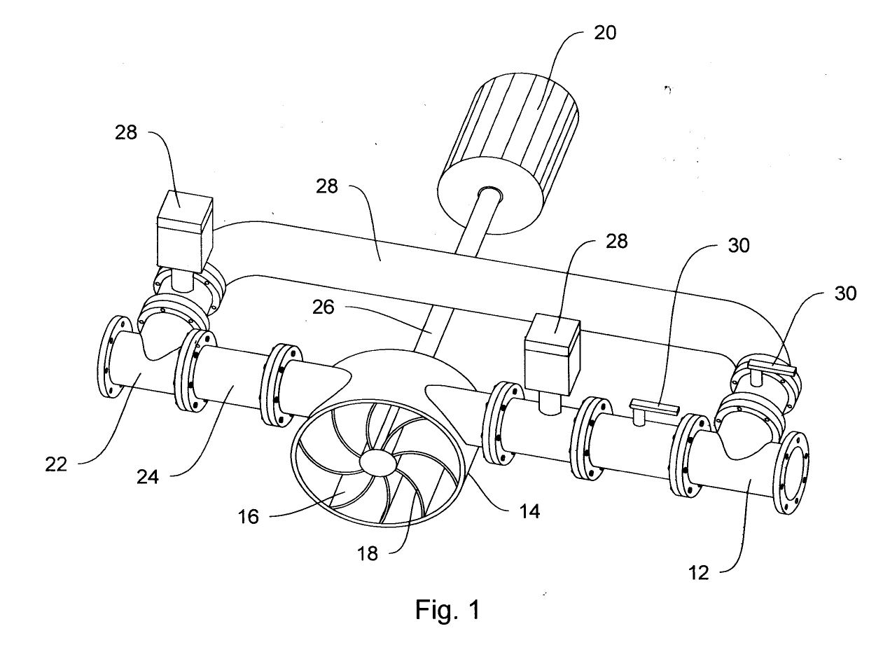

FIG. 2 is a flow chart illustrating the functioning of the water generator system, constructed in accordance with the present invention.

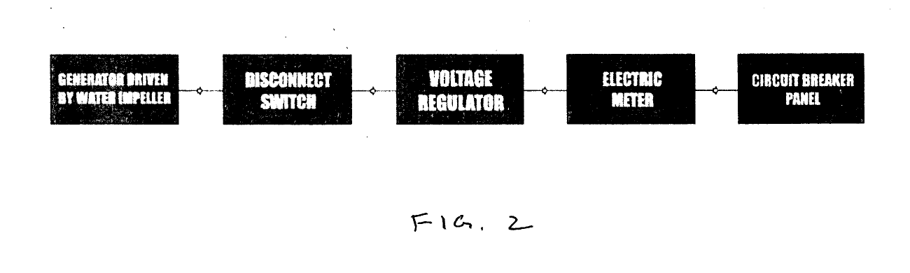

### DETAILED DESCRIPTION OF THE INVENTION

The present invention, hereinafter referred to as a Water Generator System 10, is an alternative energy source that contains a water pressure operated generator system which provides power without using fossil fuels and placing strain on a power grid. The Water Generator System 10 is an environmentally friendly, cost effective form of energy creation for consumer and commercial use. Once started by a flow of energy from water and water components, the Water Generator System 10 requires no further energy or fuel input. It should be noted that while the Water Generator System 10 has been and will be described as using water, it will be understood by those persons skilled in the art that using other fluids is within the scope of the present invention.

The Water Generator System 10 of the present invention includes an intake pipe 12 fluidly having a first end and a second end. The first end of the intake pipe 12 is fluidly connected to an existing incoming water pipe to receive the pressurized water flow from the existing water pipe. The second end of the intake pipe 12 is fluidly connected to a housing 14. Within the housing 14 is a circular impeller 16 preferably measuring approximately one half inch in width and sized appropriately in length to accommodate existing cold water piping in variously sized dwellings and buildings. Rotatably positioned inside the housing 14, the impeller 16 includes a series of paddles 18 which rotate to shift the water to a companion generator 20, as will be discussed further below. The impeller 16 is set into motion by a flow of water pressure from the intake pipe 12 which typically is, at least, one hundred fifty pounds of pressure.

In addition, the Water Generator System 10 of the present invention includes an exit pipe 22 having a first end and a second end. The first end of the exit pipe 22 is fluidly connected to the housing 14 for receiving water from the housing 14. The second end of the exit pipe 22 is connected to the water distribution system of the house or building for use by residents and/or occupants. As the water is received from the intake pipe 12 and the impeller 16, the exit pipe 22 delivers the water to the water distribution system without interference or delay for use, as desired.

In an embodiment, the water generator system 10 of the present invention further includes a check valve 24 positioned within the exit pipe 22. The check valve 24 allows fluid to flow through the exit pipe 22 in only one direction away from the housing 14.

As mentioned briefly above, the Water Generator System 10 of the present invention further includes the electric generator 20 for creating electrical power from the flow of water through the housing 14 and rotation of the impeller 16. The impeller 16 is connected to the electric generator 20 by a coupling shaft 26. In use, the movement of the water causes the impeller 16 to rotate thereby rotating the coupling shaft 26 creating centrifugal force by means of the motion of the impeller 16. The rotation of the coupling shaft 26 powers the electric generator 20 and electrical power is created.

The primary concept behind the Water Generator System 10 of the present invention involves using the energy created by a generating devices or devices. These motor driven devices are conjoined with an existing water pipe along with an impeller system. In an embodiment, a rotor inside the intake pipe 12 increases pressure and flow of a fluid.

Furthermore, the Water Generator System 10 of the present invention includes a bypass pipe 28 having a first end fluidly connected adjacent the first end of the intake pipe 12 and a second end fluidly connected adjacent the second end of the exit pipe 22 thereby bypassing the housing 14 and the enclosed impeller 16. If the impeller 16 locks up or becomes stuck, the bypass pipe 28 keeps water flowing to the residence or building and keeps water pressure up to code. Both the intake pipe 12 and the bypass pipe 28 can include both an automatic shut off valve 30 and a manual shut off valve 30 to open and close the intake pipe 12 and the bypass pipe 22 in accordance with the requirements of the Water Generator System 10. It should be noted that additional automatic shut off valves 28 and/or manual shut off valves 30 are within the scope of the present invention.

Using the Water Generator System 10 of the present invention provides a compact, water operated assembly for the creation of renewable power. The Water Generation System 10 operates efficiently to generate effective power for residences, offices and industrial applications. The Water Generation System 10 of the present invention releases no exhaust gases or particulate emissions into the atmosphere. The Water Generator System 10 functions well in emergency situations such as loss of power due to a storm or other mishap.

The Water Generator System 10 of the present invention is also designed as an apparatus producing its own electric power as needed in a dwelling or commercial or industrial application. If there is a surplus of electricity being generated, that surplus electricity can go to an electric meter, or storage device, to reduce the electric bill, or to the electric company to get a reduced rate on the electric bill.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A water generator system for providing power without using fossil fuels and placing strain on a power grid, the water generator system comprising:
an intake pipe fluidly having a first end and a second end, pressurized water entering through the first end of the intake pipe;
a housing fluidly connected to the second end of the intake pipe;
an impeller rotatably mounted within the housing, the impeller rotatable by the pressurized water;
an exit pipe having a first end and a second end, the first end of the exit pipe fluidly connected to the housing for receiving water from the housing;
a coupling shaft having a first end and a second end, the first end of the coupling shaft connected to and rotatable with the impeller; and
an electric generator connected to the second end of the coupling shaft;
wherein the electric generator creates electrical power.

2. The water generator system of claim 1 and further comprising:
a check valve positioned within the exit pipe.

3. The water generator system of claim 1 wherein the first end of the intake pipe is fluidly connected to an existing water pipe having pressurized water therein.

4. The water generator system of claim 1 and further comprising a rotor positioned within the intake pipe for increasing pressure and flow of the water.

5. The water generator system of claim 1 and further comprising:
an automatic shut off valve mounted on the intake pipe to automatically open and close the intake pipe upon the occurrence of a predetermined event.

6. The water generator system of claim 1 and further comprising:
a manual shut off valve mounted on the intake pipe to manually open and close the intake pipe.

7. The water generator system of claim 1 and further comprising:
a bypass pipe having a first end fluidly connected adjacent the first end of the intake pipe and a second end fluidly connected adjacent the second end of the exit pipe.

8. The water generator system of claim 7 and further comprising:
an automatic shut off valve mounted on the bypass pipe to automatically open and close the bypass pipe upon the occurrence of a predetermined event.

9. The water generator system of claim 7 and further comprising:
a manual shut off valve mounted on the bypass pipe to manually open and close the bypass pipe.

10. The water generator system of claim 1 wherein the impeller has a series of paddles.

11. The water generator system of claim 1 wherein the second end of the exit pipe is connected to a water distribution system of a house or building.

12. The water generator system of claim 1 wherein the system creates centrifugal force by means of the motion of the impeller.

13. A method for providing power without using fossil fuels and placing strain on a power grid, the method comprising:
providing an intake pipe fluidly having a first end and a second end;
introducing pressurized water through the first end of the intake pipe;
fluidly connecting a housing to the second end of the intake pipe;
rotatably mounting an impeller within the housing;
providing an exit pipe having a first end and a second end;
fluidly connecting the first end of the exit pipe to the housing for receiving water from the housing;
providing a coupling shaft having a first end and a second end;
connecting the first end of the coupling shaft to the impeller;
rotating the impeller by the pressurized water;
rotating the coupling shaft;
connecting an electric generator to the second end of the coupling shaft; and
creating electrical power.

14. A water generator system for providing power without using fossil fuels and placing strain on a power grid, the water generator system comprising:
an intake pipe fluidly having a first end and a second end, pressurized water entering through the first end of the intake pipe;
a first automatic shut off valve mounted on the intake pipe to automatically open and close the intake pipe upon the occurrence of a predetermined event;
a first manual shut off valve mounted on the intake pipe to manually open and close the intake pipe;
a housing fluidly, connected to the second end of the intake pipe;
an impeller rotatably mounted within the housing, the impeller rotatable by the pressurized water;
an exit pipe having a first end and a second end, the first end of the exit pipe fluidly connected to the housing for receiving water from the housing;
a coupling shaft having a first end and a second end, the first end of the coupling shaft connected to and rotatable with the impeller;
an electric generator connected to the second end of the coupling shaft;
a bypass pipe having a first end fluidly connected adjacent the first end of the intake pipe and a second end fluidly connected adjacent the second end of the exit pipe;
a second automatic shut off valve mounted on the bypass pipe to automatically open and close the bypass pipe upon the occurrence of a predetermined event;
a second manual shut off valve mounted on the bypass pipe to manually open and close the bypass pipe; and
wherein the electric generator creates electrical power.

15. The water generator system of claim 14 and further comprising:
a check valve positioned within the exit pipe.

16. The water generator system of claim 14 wherein the first end of the intake pipe is fluidly connected to an existing water pipe having pressurized water therein.

17. The water generator system of claim 14 and further comprising a rotor positioned within the intake pipe for increasing pressure and flow of the water.

18. The water generator system of claim 14 wherein the impeller has a series of paddles.

19. The water generator system of claim 14 wherein the second end of the exit pipe is connected to a water distribution system of a house or building.

20. The water generator system of claim 14 wherein the system creates centrifugal force by means of the motion of the impeller.
